(19) United States
(12) Patent Application Publication
(10) Pub. No.: US 2026/0070593 A1
(43) Pub. Date: Mar. 12, 2026

(54) METHOD FOR ENSURING THE STANDSTILL OF A RAIL VEHICLE

(71) Applicant: Siemens Mobility GmbH, München (DE)

(72) Inventors: Christian Strössner, Grossenseebach (DE); Georg Lohneis, Ebensfeld (DE)

(21) Appl. No.: 19/107,736

(22) PCT Filed: Aug. 8, 2023
(86) PCT No.: PCT/EP2023/071940

§ 371 Date: Feb. 28, 2025

(30) Foreign Application Priority Data
Aug. 30, 2022 (DE) 10 2022 208 995.2

(51) Int. Cl. B61L 27/20; B61K 9/02; B61L 27/04; B61L 27/57; B61L 27/70; B61L 99/00

(52) U.S. Cl. CPC B61L 27/20; B61K 9/02; B61L 27/04; B61L 27/57; B61L 27/70; B61L 99/002

(57) ABSTRACT

A method for ensuring the standstill of a rail vehicle, in particular ensuring the standstill of the rail vehicle for safety reasons, uses a vehicle controller of the rail vehicle having an electronic control system in order to implement driving commands and standstill commands in the rail vehicle. In addition, a monitoring instance is used, which is independent of the control system and which detects a movement of the rail vehicle, compares the detected movement with a valid driving command of the vehicle controller and, in the case of a deviation, initiates braking of the rail vehicle independently of the control system in order to bring the rail vehicle to a standstill.

The invention relates to a method for ensuring the standstill of a rail vehicle, in particular for ensuring the standstill of the rail vehicle in a safety-related manner.

In the operation of rail vehicles, it must be ensured that these rail vehicles move exclusively on the basis of a corresponding driving command.

This driving command is initiated by the train driver of the rail vehicle, wherein the driving command, as a functionality, is categorized as highly safety-critical. The reason for this is that a risk to persons must be expected in the event of an unwarranted movement of the rail vehicle. The issued driving command is implemented in the rail vehicle through software of the local electronic control system. A situation in which software errors result in an unwarranted movement of the rail vehicle via the control system must correspondingly be avoided. The control system implementing the driving command is therefore also to be categorized as highly safety-critical.

Both the development and the design of the control system, along with the associated software, must therefore be correspondingly implemented as “safety-related”. This is understood to mean an implementation,
in which both the hardware and the firmware are tested in accordance with a series of standards,
in which a development cycle or a life cycle is provided with verifications and validations,
in which a program that is as simple and as fault-resistant as possible is developed and used by means of a modular and structured programming,
in which a functional test is provided during commissioning and operation, and/or
in which suitable testing activities are provided following modifications,
etc.

Furthermore, it is assumed as an additional safety measure that the train driver can bring the rail vehicle to a safe standstill in the event of a fault by activating an emergency off switch or an emergency stop switch.

This safety measure is no longer required as soon as the train driver leaves the rail vehicle. In this case, the train driver must manually ensure that the rail vehicle is “disarmed”, i.e. that at least one high-voltage apparatus is switched off.

No suitable method for ensuring the standstill of the rail vehicle in a safety-related manner is known for a planned “autonomous operation” of the rail vehicle, which is carried out without a train driver.

The object of the present invention is therefore to indicate a method for ensuring the standstill of a rail vehicle during autonomous operation in a safety-related manner.

This object is achieved by the features of patent claim 1. Advantageous developments are indicated in the dependent patent claims.

In the method according to the invention for ensuring the standstill of a rail vehicle, the rail vehicle uses a vehicle controller having an electronic control system in order to implement driving commands and standstill commands in the rail vehicle.

In addition, a monitoring instance is used that is independent from the control system and which detects a movement of the rail vehicle, compares the detected movement with a valid driving command of the vehicle controller and, in the event of a deviation, initiates a braking independently from the control system (and therefore independently from the valid driving command) in order to bring the rail vehicle to a standstill.

Alternatively, in the event of a deviation, a drive of the rail vehicle is additionally deactivated, wherein this deactivation is similarly performed independently from the control system.

In one advantageous development, the vehicle controller, the control system and the monitoring instance are implemented in the rail vehicle or operated as integrated into the rail vehicle.

In one advantageous development, the rail vehicle is operated autonomously and without the intervention of a train driver.

In one advantageous development, the driving commands and standstill commands in the rail vehicle are issued by a landside operational control center or operational monitoring center.

In one advantageous development, the landside operational control center transmits the driving command to the rail vehicle via a secure radio link and/or by means of a secure data transmission.

In one advantageous development, the driving commands and standstill commands in the rail vehicle are issued by a train driver as valid driving commands.

In one advantageous development, in the absence of the driving command with simultaneously detected movement of the rail vehicle, the monitoring instance deactivates the drive of the rail vehicle independently from the control system and initiates the braking of the rail vehicle, similarly independently from the control system.

In one advantageous development, in order to implement the standstill, a direct intervention in drive devices and in braking devices of the rail vehicle is performed, bypassing the electronic control system.

In one advantageous development, in order to implement the standstill, a direct intervention in a main energy supply of the rail vehicle is performed, bypassing the electronic control system, in order to shut down said main energy supply.

In one advantageous development, information relating to the detected movement is transmitted to the landside operational control center together with an indication of the position of the rail vehicle.

In one advantageous development, the position indication is determined in a satellite-based manner on the rail vehicle.

In one advantageous development, the landside operational control center initiates the drive deactivation and the braking in the rail vehicle as soon as an unwarranted movement of the rail vehicle is detected.

In one advantageous development, sensors arranged on at least one axle of the rail vehicle are used for the movement detection, wherein the sensors are operated electrically independently from the vehicle control system.

In one preferred development, the rail vehicle is operated autonomously, wherein a predefined or stored timetable is followed fully automatically, on the basis of which corresponding valid driving commands are formed.

The method according to the invention enables a normal operation of a rail vehicle and an autonomous operation of the rail vehicle which is performed without the participation of a train driver.

The method according to the invention eliminates the need to monitor the standstill of a disarmed rail vehicle.

The method according to the invention is implementable without the involvement of trackside equipment.

The method according to the invention is integrable into a rail vehicle with little outlay. Rail vehicles already in operation are easily retrofittable.

The method according to the invention is simply integrable, without having to fundamentally modify the existing control system of the rail vehicle.

The method according to the invention advantageously uses a secure data connection, as described, for example, in the description of the patent application with application file reference DE 10 2022 206 426.7, filed on Jun. 27, 2022.

The solutions described therein are incorporated by reference into the present description.

The invention is explained in detail below with reference to a drawing, in which:

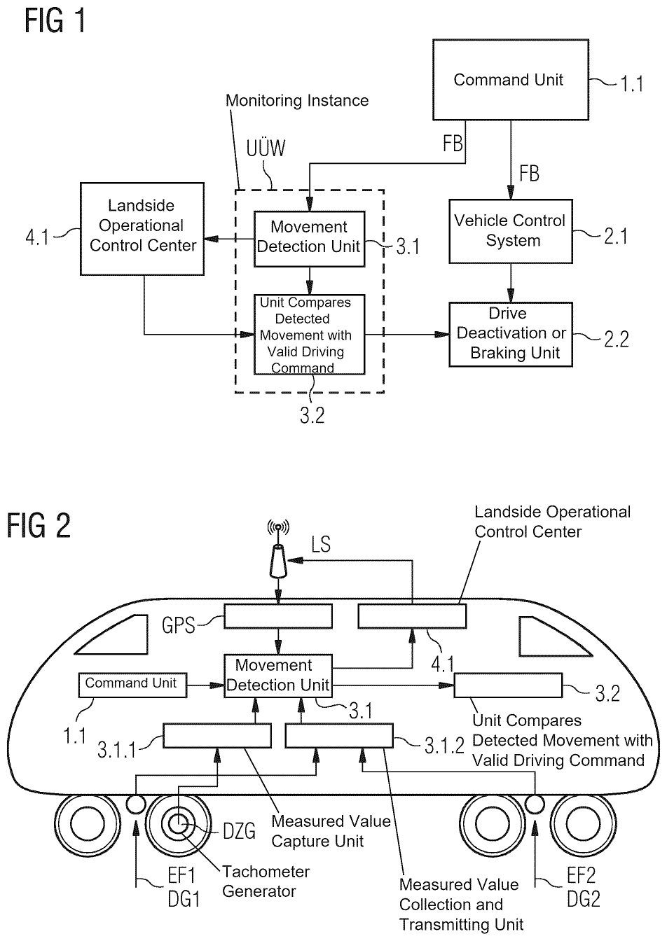

FIG. 1 shows a basic overview of the method according to the invention,

FIG. 2 shows, with reference to FIG. 1, a more detailed example of a description of the movement detection by means of the units 3.1 shown in FIG. 1, and

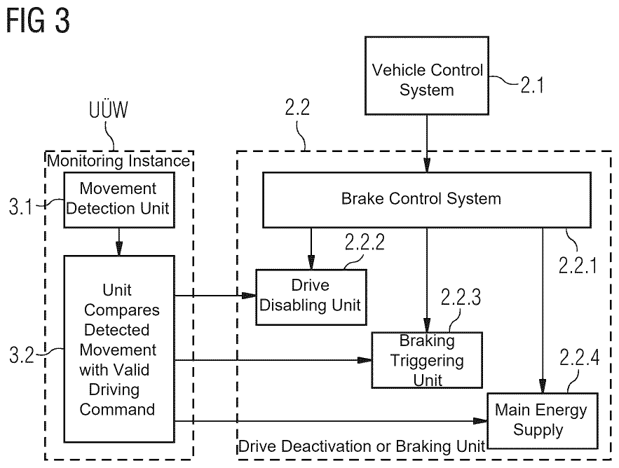

FIG. 3 shows, with reference to FIG. 1 and FIG. 2, an overview of details of the independent deactivation of the drive and of the initiation of the braking procedure.

FIG. 1 shows a basic overview of the method according to the invention in a block diagram.

The term “unit” is used below. This term is to be understood in the sense of a functionality which is ensured by means of modules, components, etc.

The method according to the invention uses a command unit 1.1, with which a driving command FB is generatable to start the rail vehicle.

The absence of the driving command FB is interpreted as preventing the movement of the rail vehicle, which must then accordingly remain at a standstill.

A landside operational control center, for example, which transmits the driving command FB to the rail vehicle via a secure radio link or by means of a secure data transmission, is used as the command unit 1.1.

Alternatively, a command unit 1.1 is used which is installed locally on the rail vehicle and is operated there.

In one preferred development, a predefined or stored timetable, on the basis of which a respective valid driving command is formed, is followed fully automatically during the autonomous operation of the rail vehicle with the involvement of the command unit 1.1.

The driving command FB is forwarded from the command unit 1.1 to a (regular, already known) control system or vehicle control system 2.1 which processes the driving command FB according to its specification and controls driving and braking devices of the rail vehicle by means of a unit 2.2.

A monitoring instance UÜW that is independent from the driving command FB is provided in parallel thereto.

This monitoring instance UÜW is designed as autonomous and is able to detect any movement, even an incipient movement, of the rail vehicle, to compare the detected movement with the valid driving command FB and, in the event of a deviation, to deactivate the drive of the rail vehicle or initiate a braking of the rail vehicle by means of the unit 2.2 independently from the control system (and therefore independently from the valid driving command FB).

The independent monitoring instance UÜW uses a unit 3.1 for the movement detection, wherein the movement detection is described in more detail below.

The independent monitoring instance UÜW uses a unit 3.2 which is located downstream of the unit 3.1 and with which the detected movement is compared with the valid driving command FB.

A deviation is identified as a fault by the unit 3.2, which accordingly instigates a deactivation of the drive that is independent from the control system and a braking of the rail vehicle that is independent from the control system by means of the unit 2.2.

To do this, the unit 3.2 preferably disables the drive by means of a direct electrical intervention.

Alternatively or additionally, a main energy supply of the rail vehicle is switched off through direct electrical interventions.

For Example:
a connection from an overhead wire to the rail vehicle is interrupted, or
a connection between a diesel generator arranged in the rail vehicle and an internal main energy supply is interrupted in the rail vehicle, or
a connection between a main accumulator (on-board battery) arranged in the rail vehicle and an internal main energy supply is interrupted in the rail vehicle,
etc.

Alternatively or additionally, braking is activated by a direct intervention in a pneumatic main brake line of the rail vehicle or possibly in further braking devices.

In parallel thereto, for the movement detection, the unit 3.1 continuously transmits information relating to the movement or the incipient movement, preferably together with location information, to a landside operational control center 4.1.

Optionally, the operational control center 4.1 similarly has a facility to initiate braking in the rail vehicle as soon as an unwarranted movement of the rail vehicle is detected.

The operational control center 4.1 thereby has the facility to compare this information with its own timetable information. If it concludes that the vehicle movement is unwarranted, it has the facility, by transmitting a command via the same data connection, to prompt the unit 3.2 to shut down in order to force the vehicle to a standstill.

This action is optional, and is to be understood as an additional safety measure. It is appropriate particularly if information relating to timetables or to necessary vehicle movements is suddenly available which is not yet present on the vehicle.

FIG. 2 shows, with reference to FIG. 1, a more detailed example of a description of the movement detection by means of the unit 3.1.

The unit 3.1 for the movement detection preferably uses a plurality of independent sensors for that purpose, for example one or more tachometer generators DZG, which are arranged on one or more axles of the rail vehicle.

Associated measured values are forwarded to a unit 3.1.1, which captures the measured values and then transmits the measured values to the unit 3.1 for the movement detection.

Alternatively or additionally, sensors EF1 and EF2 are used, by means of which an increasing tractive force is measured on one or more of the bogie axles DG1, DG2 of the rail vehicle. The associated measured values are transmitted to the unit 3.1.2, which collects the measured values and transmits them to the unit 3.1.

Position changes of the rail vehicle are monitored and detected by means of a satellite-based unit GPS. A change in the position which moves outside a predefined position tolerance, indicates an incipient movement of the rail vehicle. This information is also transmitted to the unit 3.1.

The described sensors are operated electrically independently from the vehicle control system 2.1.

The unit 3.1 for the movement detection detects a movement or an incipient movement of the rail vehicle on the basis of the transmitted measured values or on the basis of the associated information.

If an unwarranted movement is detected on the basis of a deviation from the driving command FB, the unit 3.1, as described above, transmits a command that is independent from the control system to deactivate the drive and a command to activate the brake to the unit 3.2, which is described more precisely below.

In parallel thereto, the unit 3.2 continuously transmits information relating to the movement together with location information to the landside operational control center 4.1 by means of a suitable radio link.

FIG. 3 shows, with reference to FIG. 1 and FIG. 2, an overview of details of the independent deactivation of the drive and of the initiation of the braking procedure.

As described above, the unit 3.2 is coupled to the monitoring instance UÜW.

The unit 3.2 accesses the unit 2.2 electrically and functionally independently from the control system of the rail vehicle.

More precisely, it acts directly on a unit 2.2.2 which is used for the drive, and is capable of electrically disabling the drive via this unit in any operational state, so that no further driving force can be generated.

The unit 3.2 further acts directly on a unit 2.2.3 which is used for braking, and is capable of triggering a pneumatic braking via this unit, wherein said braking is independent from an associated brake control system 2.2.1.

Access to further, non-pneumatic braking systems is optionally provided, for example a spring-loaded brake is triggered if required.

The unit 3.2 further acts directly on a main energy supply 2.2.4 of the rail vehicle, said main energy supply comprising a high-voltage device, a main accumulator, a diesel generator, etc., depending on the vehicle type. A disabling or disconnection electrically that is independent from the associated control system is thereby enabled.

1-14. (canceled)

15. A method for ensuring a standstill of a rail vehicle, the method comprising:
operating the rail vehicle autonomously and without an intervention of a train driver;
using a vehicle controller having an electronic control system to implement driving commands and standstill commands in the rail vehicle;
using a landside operational control center to issue the driving commands and standstill commands in the rail vehicle;
using a monitoring instance being independent from the control system to detect a movement of the rail vehicle, compare the detected movement with a valid driving command of the vehicle controller and, in an event of a deviation, initiate a braking being independent from the control system to bring the rail vehicle to a standstill;
using sensors disposed on at least one axle of the rail vehicle for the movement detection, and operating the sensors electrically independently from the vehicle control system; and
using a sensor on the axle of the rail vehicle for motion detection, the sensor detecting an increasing tractive force on a bogie axle of the rail vehicle.

16. The method according to claim 15, which further comprises, in the event of the deviation, additionally deactivating a drive of the rail vehicle, and performing the deactivation independently from the control system.

17. The method according to claim 15, which further comprises using the landside operational control center to transmit the driving command to the rail vehicle at least one of over a secure radio link or by using a secure data transmission.

18. The method according to claim 15, which further comprises, in an absence of the driving command with a simultaneously detected movement of the rail vehicle, using the monitoring instance to at least one of deactivate the drive of the rail vehicle independently from the control system or initiate the braking independently from the control system.

19. The method according to claim 15, which further comprises implementing the standstill by performing a direct intervention in drive devices and in braking devices of the rail vehicle, bypassing the electronic control system.

20. The method according to claim 15, which further comprises implementing the standstill by performing a direct intervention in a main energy supply of the rail vehicle, bypassing the electronic control system, to shut down the main energy supply.

21. The method according to claim 15, which further comprises transmitting information relating to the detected movement to the landside operational control center together with an indication of a position of the rail vehicle.

22. The method according to claim 21, which further comprises determining the position indication in a satellite-based manner on the rail vehicle.

23. The method according to claim 15, which further comprises using the landside operational control center to initiate the braking in the rail vehicle as soon as an unwarranted movement of the rail vehicle is detected.

24. The method according to claim 15, which further comprises using a tachometer generator, disposed on an axle of the rail vehicle, as a sensor.
